(19) United States
(12) Patent Application Publication
(10) Pub. No.: US 2005/0013100 A1
(43) Pub. Date: Jan. 20, 2005

(54) Rotatably retractable image display system

(75) Inventors: Thomas M. Stephany, Churchville, NY (US); Richard W. Wien, Pittsford, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/621,898

(22) Filed: Jul. 17, 2003

(51) Int. Cl. G06F 1/16

(52) U.S. Cl. 361/681

(57) ABSTRACT

A system for displaying images includes: (a) a base; (b) a movable, arcuate-shaped receptacle that rotates into and from the base; and (c) a display attached to the receptacle so that the display is visible when the receptacle is rotated from the base and the display is partially or entirely not visible when the receptacle is rotated into the base.

### FIELD OF THE INVENTION

The invention relates generally to the field of displays and display enabled devices and, more particularly, to such devices having an arcuate-shaped rotatable enclosure that holds a display which, when retracted, is safely hidden and protected from viewing. This system of the present invention, when rotatably retracted, both removes power from the display or system, and protects the display screen. The rotatable arcuate-shaped display enclosure comprises an extremely safe and padded surface; the surface having no injurious portions making the use of this implementation highly desirable in aircraft, automobiles and consumer devices for the prevention of injuries to a user. There exists no sharp edges or flimsy flat panels to break. When the display is extracted from the arcuate-shaped housing the display displays normally, but is still recessed and still possesses all the afore properties. The implementation improves robustness, safety and maintenance costs that make this display system especially advantageous.

### BACKGROUND OF THE INVENTION

Display systems are currently available for permitting viewing of images thereon. They are commonly used in automobiles such as police cars, and aircraft for showing movies and the like. Such displays are available from a number of sources including Sanyo and Sony of Japan, and Philips in the Netherlands. Displays are also commonly used in laptop computers from a variety of manufacturers such as IBM. These types of displays demonstrate extreme drawbacks for many mobile applications in that they include sharp square edges which are unsafe in an accident and generally delicate if not carefully retracted into a closed position.

Although these currently available technologies are demonstrated as being satisfactory for rudimentary consumer purposes, they are not acceptable for use in value applications such as automobiles and aircraft where safety and ruggedness and low service costs are necessary and desirable. Therefore, a need exists for providing improved retractable display systems that are acceptable for widespread commercial adoption.

### SUMMARY OF THE INVENTION

The present invention is directed to overcoming one or more of the problems set forth above. Briefly summarized, according to one aspect of the present invention, the present invention resides in a system for displaying images comprising a base; which contains a movable, arcuate-shaped display receptacle that rotates into and out of the base, and a display attached to the receptacle so that the display is visible when the receptacle is rotated from the receptacle and the display is partially or entirely not visible when the receptacle is rotated into the base.

The above and other objects of the present invention will become more apparent when taken in conjunction with the following description and drawings wherein identical reference numerals have been used, where possible, to designate identical elements that are common to the figures.

Advantageous Effect of the Invention

The present invention has the advantage of providing safe, robust and low maintenance cost viewing in a relatively small device. It also includes the ability of viewing when rotatably extracted, and not being viewed when rotatably retracted. Extreme safety is achieved by virtue of the arcuate-shaped cylindrical design.

### BRIEF DESCRIPTION OF THE DRAWINGS

FIG. 1 is a perspective view of an arcuate-shaped display tube and its respective arcuate-shaped receptacle;

FIG. 1a is a perspective view of system such as a PDA or computer with the arcuate-shaped display receptacle rotated into the base;

FIG. 1b is a perspective view of system such as a PDA or computer with the arcuate-shaped display receptacle rotated out of the base;

FIG. 2 is a rear perspective view of a chair such as might be found in commercial aircraft or an automobile with an arcuate-shaped display as part of the headrest with the arcuate-shaped display receptacle rotated into and out of its base;

FIG. 3a is a side view of a ceiling mounted display in front of a chair showing the arcuate-shaped display rotated into its base; and

FIG. 3b is a side view of a ceiling mounted display in front of a chair showing the arcuate-shaped display rotated out of its base.

### DETAILED DESCRIPTION OF THE INVENTION

In the following description, the present invention will be described in the preferred embodiment as a system displaying images. The invention refers to a safe, robust and low maintenance viewing system that can be part of a small device. In particular the display is protected against accidental dropping when used in a PDA or a computer system and an object or person striking it when used in a system in a commercial or consumer vehicle. In the latter case this provides protection for the display as well as users.

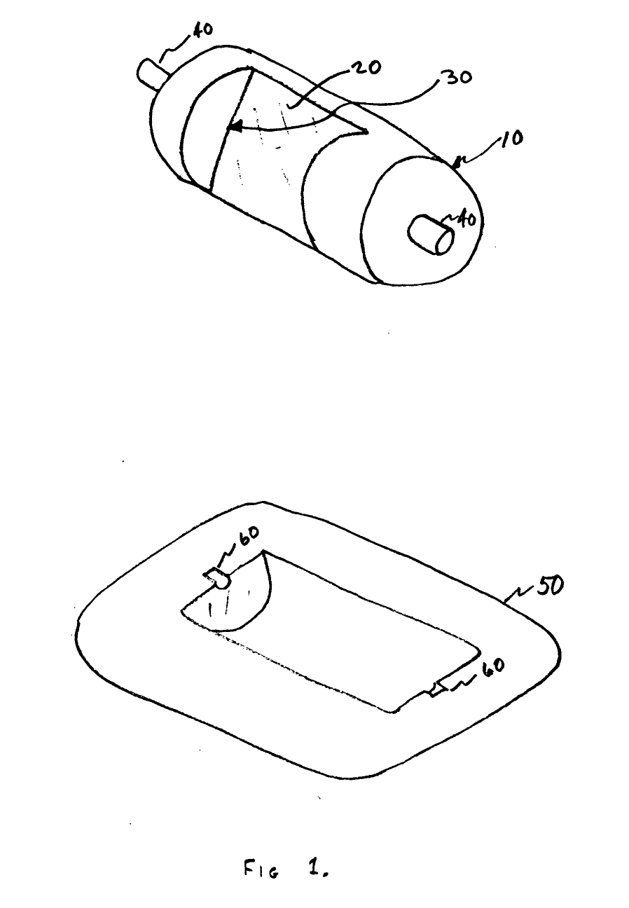

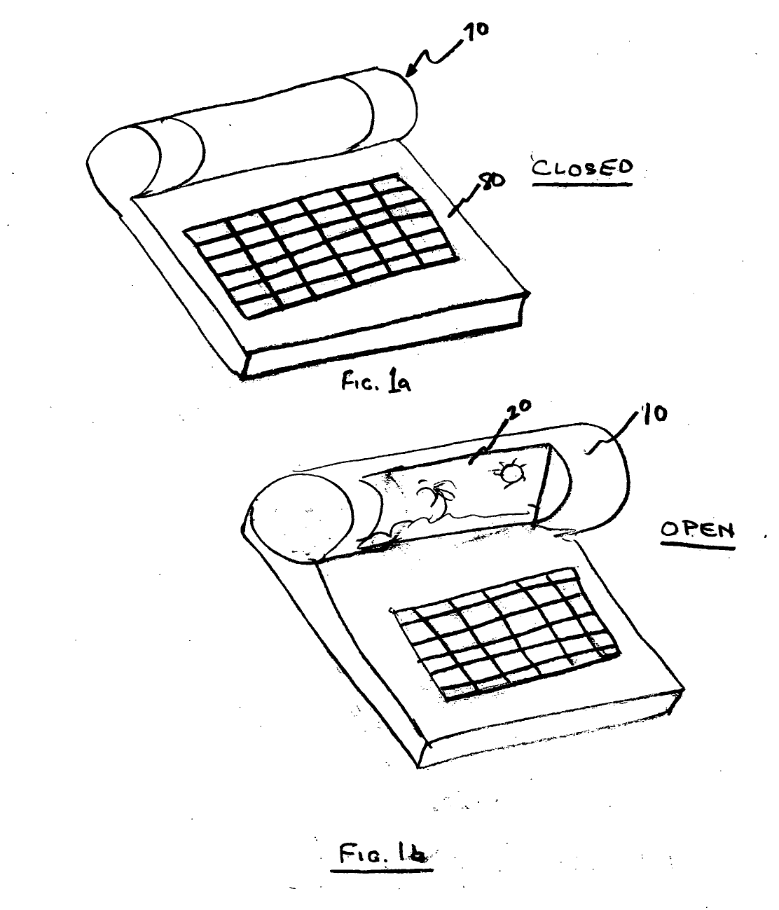

Referring first to FIG. 1, a drawing of an arcuate-shaped display tube 10 is represented upon which a display 20 is attached. The attached display 20 can be constructed from a number of technologies such as LCD or Organic LED'S, and is displaced upon a flat section 30 of the display tube 10. The flat section 30 can be rotated about the two rotational members 40. This configuration allows the display 20 to be rotated into an arcuate-shaped base 50 and rotational member receptacles 60.

Referring now to FIG. 1a, a consumer device such as a PDA 70 is shown and is represented in a manner in which a display is rotated into the PDA base 80, representing a closed position.

Referring next to FIG. 1b, the display 20 is rotated out of the PDA base 80 and represents an open and operational condition. When closed, the display 20 is protected and through the use of an automatic off/on switch (not shown), power is removed by being actuated at some predetermined position within the rotation of the arcuate-shaped tube 10. When the display 20 is rotated to the open position, determined by the aforementioned predetermined position, the power is automatically turned on and the display 20 is ready for viewing.

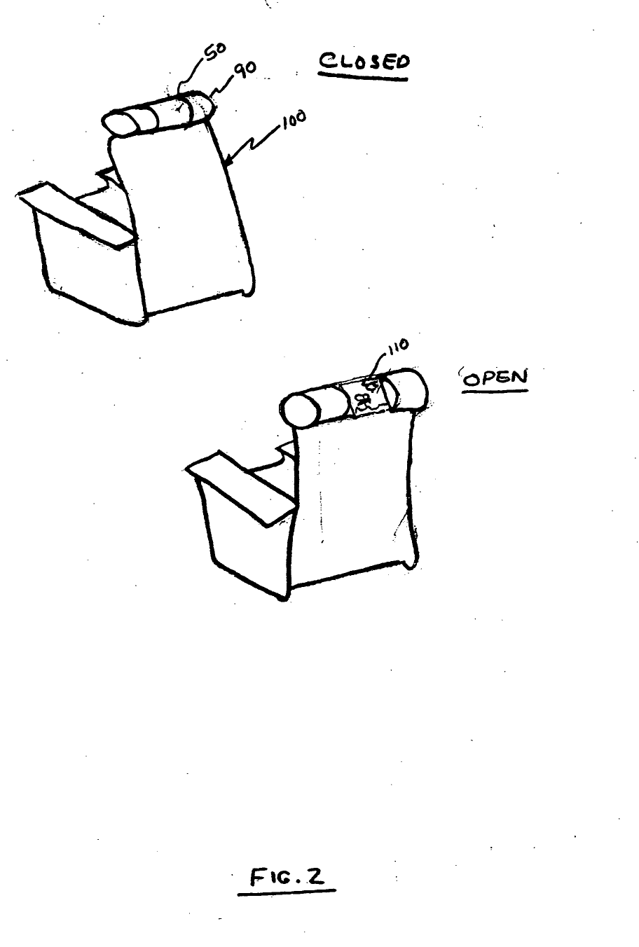

Referring to FIG. 2, seen is an embodiment where the arcuate-shaped display receptacle 50, (from FIG. 1) is designed to be part of the headrest 90 of a chair 100 such as might be found on an airplane, train, or bus. The headrest 90 appears as one continuous piece when display is rotated into the base but upon rotation away from the base the person sitting behind the chair is able to view a high quality display 110. Simply rotating the display turns it off and with no sharp edges provides a supreme measure of safety. It is known that sharp edged interior surfaces contribute to severity of injuries when passengers accidentally fall or are thrust into these surfaces. Therefore, removal of the sharp edges will result in reduced severity of injuries.

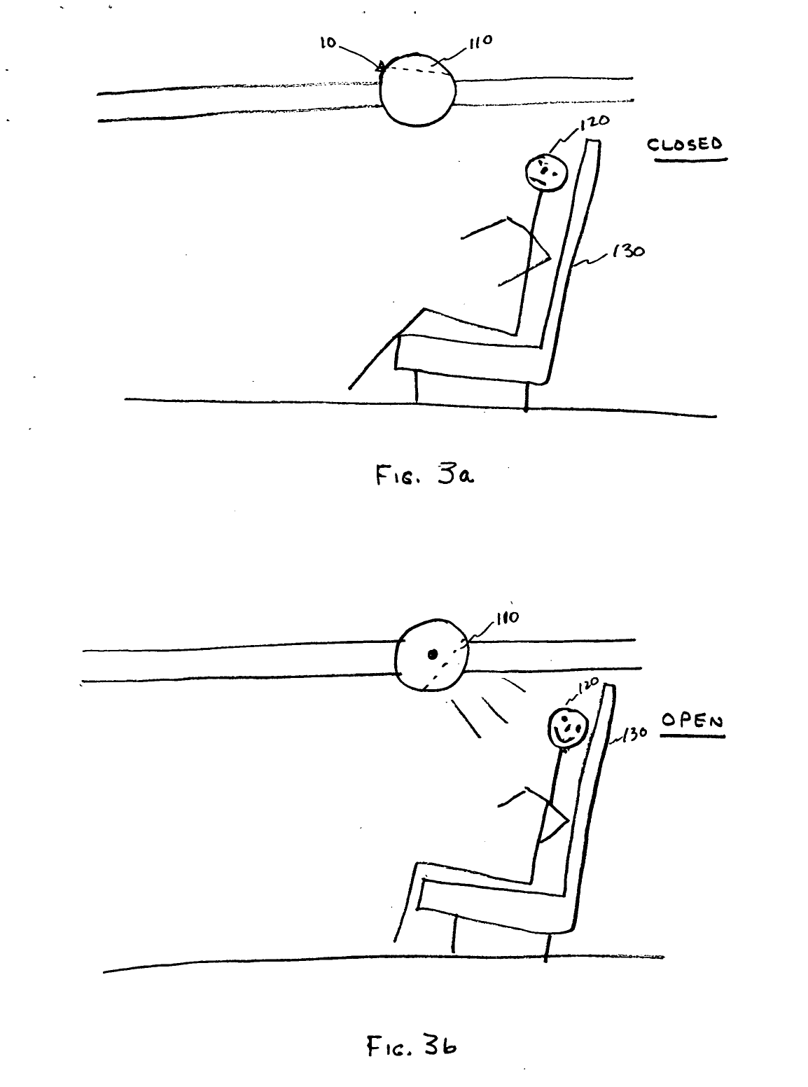

Referring to FIG. 3a is an embodiment wherein a high quality display 110 is mounted above a person 120 as for example in an airline seat 130. Rotating the arcuate-shaped tube 10 (from FIG. 1), allows the person 120 to align the high quality display 110 for optimum viewing as shown in FIG. 3b. Note that in current embodiments on airplanes, displays are often rectangular shaped and hazardous wherein the current embodiment provides additional passenger safety and robustness.

The invention has been described with reference to a preferred embodiment. However, it will be appreciated that variations and modifications can be effected by a person of ordinary skill in the art without departing from the scope of the invention.

### Parts List

10 arcuate-shaped display tube
20 display
30 flat section
40 rotational members
50 arcuate-shaped base (display receptacle)
60 rotational member receptacles
70 PDA
80 PDA base
90 headrest
100 chair
110 high quality display
120 person
130 airline seat

1. A system for displaying images comprising:
(a) a base;
(b) a movable, arcuate-shaped receptacle that rotates into and from the base;
(c) a display attached to the receptacle so that the display is visible when the receptacle is rotated from the base and the display is partially or entirely not visible when the receptacle is rotated into the base.

2. The system as in claim 1, wherein the display is a flat-panel display.

3. A self-propelled vehicle for moving in air, on land or on water, the vehicle comprising:
(a) a system for displaying images comprising:
(i) a base;
(ii) a movable, arcuate-shaped receptacle that rotates into and from the base;
(iii)a display attached to the receptacle so that the display is visible when the receptacle is rotated from the base and the display is partially or entirely not visible when the receptacle is rotated into the base.

4. The self-propelled vehicle as in claim 1, wherein the display is a flat-panel display.
